(19) United States
(12) Patent Application Publication
(10) Pub. No.: US 2007/0051907 A1
(43) Pub. Date: Mar. 8, 2007

(54) Device for generating X-ray or XUV radiation

(76) Inventor: Alfred Reinhold, Wunstorf (DE)

Correspondence Address: SHLESINGER, ARKWRIGHT & GARVEY LLP, 1420 KING STREET, SUITE 600, ALEXANDRIA, VA, 22314, US

(21) Appl. No.: 11/515,382

(22) Filed: Sep. 5, 2006

(30) Foreign Application Priority Data
Sep. 3, 2005 (DE) 10 2005 041 923.2

(51) Int. Cl. G01J 3/10

(52) U.S. Cl. 250/504 R

(57) ABSTRACT

Device for generating X-ray or XUV radiation includes a device for directing a particle beam of electrically charged particles towards a target. A deflection device for deflecting the particle beam is such that the central axis of the particle beam passes through a first point of deflection and a second point of deflection located at a distance from the first point of deflection in the direction of propagation of the beam. The first and second points of deflection lie on an axis in line with a determined or determinable point of impact of the particle beam with the target. The particle beam can be deflected by the deflection device in the direction of propagation of the beam in the region of one point of deflection independently from of a deflection of the particle beam in the region of the other point of deflection.

### CROSS-REFERENCE TO RELATED APPLICATIONS

This application claims priority of German Application No. 10 2005 041 923.2, filed Sep. 3, 2005, and which is incorporated herein by reference.

### FIELD OF THE INVENTION

This invention relates to a device for generating X-ray or XUV radiation including a device for directing a particle beam of electrically charged particles towards a target, and including a deflection device for deflecting the particle beam in such a way that the central axis of the particle beam passes through a first point of deflection and a second point of deflection located at a distance from the first point of deflection in the direction of propagation of the beam. The deflection device includes a first deflector for deflecting the particle beam in such a way that the central axis of the particle beam passes through the first point of deflection, and a second deflector at a distance from the first deflector in the direction of propagation of the beam , in order to deflect the particle beam in such a way that the central axis of the particle beam passes through the second point of deflection, and the particle beam can be deflected by the deflectors with respect to one point of deflection independently from a deflection with respect to another point of deflection.

### BACKGROUND OF THE INVENTION

Devices of this type are known for generating X-rays, for example, in the form of X-ray tubes, as is known from U.S. Pat. No. 3,793,549, and GB 1 057 284 and for generating XUV-rays, for example, as is known from WO 2004/023512 A1, U.S. Pat. No. 3,138,729, EP 0 887 639 A1, and U.S. Pat. No. 4,523,327. The term XUV (extreme ultraviolet) radiation is understood to be radiation in a wavelength range between about 0.25 and 20 nm. The known devices especially are used in imaging processes, for example, when examining electronic components, especially printed circuit boards, as well as for controlling and adjusting optical components.

The known devices include devices for directing a particle beam of electrically charged particles towards a target, wherein the material of the target is selected corresponding to the desired wavelength of the emitted radiation.

A disadvantage of the known devices is that a deviation of the point of impact of the particle beam on the target from a specified point of impact will impair the image quality of the images generated by way of irradiation of components and result in errors of measurement when performing measuring and adjustment functions, as well as adjustment tasks.

### OBJECTS AND SUMMARY OF THE INVENTION

An object of this invention is to provide a device of the type for generating X-ray or XUV radiation including a device for directing a particle beam of electrically charged particles towards a target, and including a deflection device for deflecting the particle beam in such a way that the central axis of the particle beam passes through a first point of deflection and a second point of deflection located at a distance from the first point of deflection in the direction of propagation of the beam. The deflection device includes a first deflector for deflecting the particle beam in such a way that the central axis of the particle beam passes through the first point of deflection, and a second deflector at a distance from the first deflector in the direction of propagation of the beam of the particle beam, in order to deflect the particle beam in such a way that the central axis of the particle beam passes through the second point of deflection, and the particle beam can be deflected by the deflectors with respect to one point of deflection independently from a deflection with respect to another point of deflection. The object being that the deviations of the point of impact of the particle beam on the target from a specified point of impact are reduced, and that the local stability of the particle beam thus is improved in terms of its point of impact on the target.

This object is achieved by the teachings of a device of this type in which each of the deflectors is constructed for deflecting the particle beam along two vertical axes (x-axis and y-axis), in such a way that the first and the second points of deflection lie on an axis in line with a predetermined or predeterminable point of impact of the particle beam on the target.

The basic concept of the inventive teaching includes providing a deflection device for deflecting the particle beam and as a result of which the particle beam is deflected in such a way that the central axis of the beam passes through a first and a second point of deflection, and that the first and second points of deflection lie on an axis in line with a predetermined or predeterminable point of impact of the particle beam on the target, and that the particle beam can be deflected by the deflection device with respect to one point of deflection independently from a deflection with respect to the another point of deflection.

Due to the fact that, according to the invention, the particle beam always passes through the first and the second points of deflection and these points of deflection lie on an axis in line with the desired point of impact of the particle beam on the target, a high degree of local stability is achieved in terms of the point of impact of the particle beam on the target. In this connection, it is a fundamental aspect of the invention that, as a result of the effect of the deflection device, the particle beam passes through at least two points of deflection which are in line with the desired point of impact of the particle beam on the target. In other words, as a result of the independent deflection or deflectability of the particle beam with respect to two points of deflection located at a distance from one another in the direction of propagation of the beam, and which are in line with the desired point of impact of the particle beam, it is ensured that the central axis of the particle beam is coincident with a hypothetical straight line, on which the first and second point of deflection, and the desired point of impact on the target are located.

The central axis of the particle beam may, for example and in particular, be coincident with a central axis of the inventive device, for example, an X-ray tube.

According to the invention, it basically suffices if the deflection devices are configured for an independent deflection with respect to the first point of deflection and the second point of deflection at a distance to the first point of deflection in the direction of propagation of the beam. In order to avoid an undesired deflection of the particle beam after passing through the second point of deflection, according to the invention, it is also possible to deflect the particle beam by way of a deflection device in such a way that the beam passes not only through the first and second points of deflection, but in the direction of propagation of the beam passes through additional points of deflection located behind the second point of deflection, and wherein all points of deflection may be located in the same axis with the desired point of impact of the particle beam on the target.

This is advantageous, especially if there is a large distance between the second point of deflection and the target. If the particle beam with respect to the first and the second points of deflection is deflected, for example and especially, by a first and a second deflector, according to the present invention, it is possible to provide further deflectors in addition to these deflectors, which are arranged in the direction of propagation of the beam behind the second deflector unit.

By the term “central axis of the particle beam” as used herein is meant an axis which passes through the geometric center of the cross-section of the particle beam.

Basically, according to the present invention, it is sufficient if the deflection device includes a single deflector, provided this enables an independent deflection of the particle beam with respect to the first point of deflection and the second point of deflection at a distance from the first point of deflection in the direction of propagation of the beam. An advantageous embodiment of the inventive teaching provides that the deflection device includes a first deflector, for deflecting the particle beam in such a way that the central axis of the beam passes through the first point of deflection, and a second deflector, for deflecting the particle beam, at a distance from the first deflector in the direction of propagation of the particle beam, so that the central axis of the particle beam passes through the second point of deflection. Since the deflectors essentially can have an identical structure, the engineering expenditures for a device according to the invention can be kept low.

Appropriate controlling devices are provided for controlling the deflection device and deflectors, respectively.

Another further variation of the embodiment including the deflectors provides that the first deflector and the second deflector are controllable independently by the controlling device for the independent deflection of the particle beam with respect to the first point of deflection and the second point of deflection. By this method, the particle beam can be deflected with a particularly high degree of precision.

With the embodiments including deflectors, each of the deflectors appropriately is provided with at least one deflection element. According to the respective requirements, more than one deflection element can be provided per deflector.

The shape, size, quantity and configuration of the deflection elements can be selected within wide limits. An advantageous embodiment provides that the deflection element at least includes at least one coil or coil configuration, especially a quadrupole. Coils of this type are available as simple and low-cost standard components and, by controlling a corresponding deflection current, enable a precise deflection of the particle beam.

Another embodiment of the inventive teaching provides that the deflection element includes at least one electrostatic deflection plate.

Another advantageous embodiment of the inventive teaching provides that each deflection device is configured for deflecting the particle beam in the direction of two vertical axes. If the central axis of the particle beam, for example, runs in the Z-direction, in this embodiment the deflection device is configured, for example, for deflecting the particle beam along the X-direction and the Y-direction.

Another advantageous embodiment of the inventive teaching provides that at least one of the deflectors is provided with an aperture, which is arranged in the direction of propagation of the beam behind the deflection element of the deflector. The aperture, for example and especially, can be used for measuring an electric current resulting from the impact of the particle beam on the aperture, and the deflection of the particle beam can be controlled as a function of the measured current, as is explained in greater detail in the following.

A further variation of the aforesaid embodiment provides that the first aperture is provided for the first deflection unit, and that the first aperture, in the direction of propagation of the beam is located in the region of a plane of action of a deflection element of the second deflector. In terms of the deflection of the particle beam in the direction of propagation of the beam in the region of the second point of deflection, this method produces particularly favorable conditions.

Another further variation of the embodiment including the aperture provides that a second aperture is provided for the second deflector. The function of the second aperture provided for the second deflector can be similar to that of the first aperture provided for the first deflector.

An extraordinarily advantageous embodiment of the inventive teaching provides that at least one aperture at least partially is made of an electrically conductive material and that a measuring unit for measuring an electric current is provided for the aperture, the current resulting from an impact of the particle beam on the aperture. In this embodiment, an electric current is measured by way of the measuring unit, in that on impact of the particle beam onto the aperture and/or an electrically conductive part of the aperture the current flows. If the particle beam passes through the opening of the aperture without the electrically charged particles impacting the aperture, ideally no current will flow, while during a complete impact of the particle beam on the aperture a relatively high current flows. The measured current thus is a measure of the deviation of the central axis of the particle beam from the desired position. If it is determined by way of the current measured by the measuring unit that, for example, the particle beam completely impacts the aperture, the deflection unit provided for the aperture can be so controlled such that the particle beam no longer impacts the aperture, but rather passes through the opening of the aperture. With smaller angles of deflection of the particle beam, a proportionality exists between the current of deflection and the deflection path of the particle beam.

In this sense, an advantageous embodiment of the inventive teaching provides that the measuring unit is connected with the controlling device for controlling the deflection device in such a way that the particle beam is deflected as a function of the current measured by the measuring unit.

Another advantageous embodiment of the inventive teaching provides that an aperture located opposite the target is provided for a measuring unit, which in an initial mode of operation measures the electric current resulting from the impact of the particle beam on the surface of the aperture facing the target, and which in a second mode of operation measures an electric current, which results from the electrically charged particles, which are backscattered from the target. With this embodiment, the output signal of the measuring unit can be used, for example, in the first mode of operation to determine a deflection current for controlling the respective deflector, in order to deflect the particle beam in such a way that it passes through the desired point of deflection. By contrast, in a second mode of operation, the current measured by the measuring unit may be used to regulate or control the target current of the target of the device by controlling a particle source, which generates the particle beam.

For this purpose, an advantageous embodiment of the aforesaid embodiment provides that the measuring unit is connected with a regulating and/or controlling device, which, as a function of the current measured by the measuring unit in the second mode of operation, regulates or controls the target current by controlling a particle source for generating the particle beam.

In order to achieve the desired focused diameter of the focus of the particle beam on the target, another advantageous embodiment of the inventive teaching provides a focusing device for focusing the particle beam on the target.

With the aforesaid embodiment, the focusing device is appropriately located behind the deflection device in the direction of propagation of the beam. With this embodiment, the particle beam first is deflected in the desired position in that the central axis of the beam passes through the first and the second points of deflection. Subsequently, the electron beam is focused by way of the focusing device, in order to achieve the desired focusing diameter on the target.

In the following, this invention is explained in detail by way of the attached schematic diagrams, in which an embodiment of an inventive device is presented. Further, all features described or shown in the drawings, individually or in any combination, define the object of the invention, irrespective of their combination(s) set forth in the claims or the references to the claims, as well as irrespective of their definition, and/or presentation in the patent specification, and/or in the drawing.

### BRIEF DESCRIPTION OF THE DRAWINGS

FIG. 1 shows a schematic sectional view of a first embodiment of an inventive device;

FIG. 2 in a presentation similar to FIG. 1 shows a similar view of the device according to FIG. 1 to elucidate the way it functions; and

FIG. 3 shows a schematic sectional view of an aperture used in the inventive device according to FIG. 1.

### DETAILED DESCRIPTION OF THE INVENTION

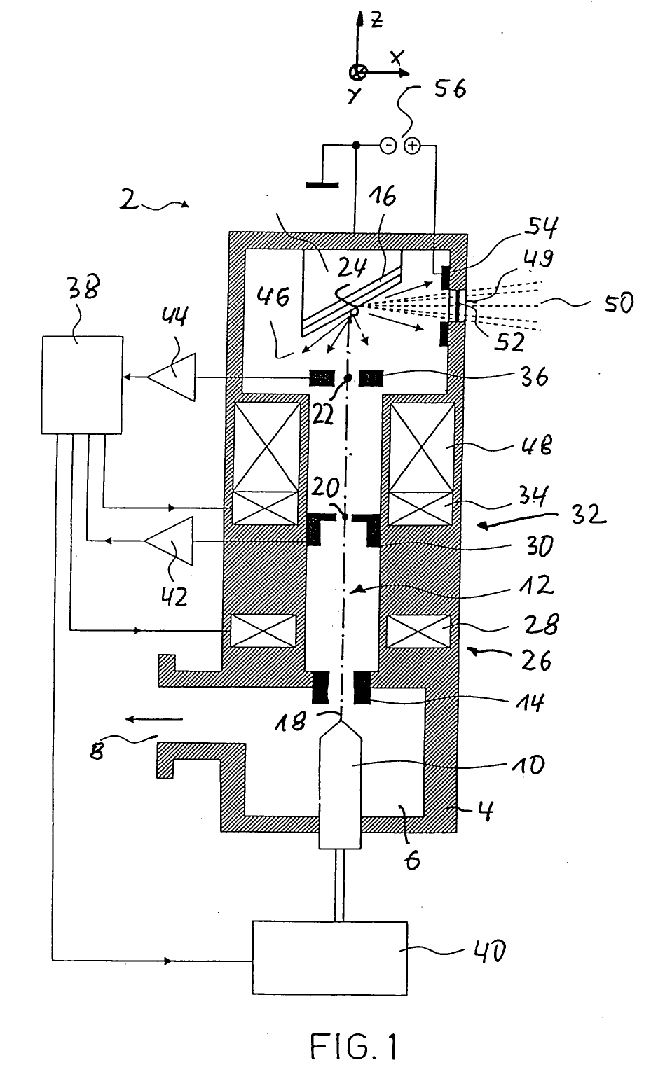

FIG. 1 shows an example of an inventive device 2, which in this embodiment serves to generate XUV radiation. The device 2 is embodied in the form of an X-ray tube, and includes a housing 4, the interior 6 of which is embodied as a vacuum chamber and can be evacuated by way of a vacuum pump (not shown) via an opening 8.

Inside the vacuum chamber 6, a particle source 10 is provided for generating a particle beam of electrically charged particles, wherein in this embodiment the electrically charged particles are formed by electrons discharged from a cathode. The electrons are accelerated to form a particle beam 12 by way of an annular anode 14 in the direction towards a target 16, which in this embodiment is shaped as a layer target. When impacting the target 16, the electrons forming the particle beam 12 are slowed down, as a result of which radiation (Bremsstrahlung) is created, the spectrum of which depends on the energy of particles and the chemical structure (atomic number) of the material of the target 16. With the embodiment shown in FIG. 1, the material of the target 16 is selected so that radiation is generated, which contains a usable portion in the XUV spectral range.

According to the invention, the device 2 includes a device for deflecting the particle beam 12 in such a way that the central axis of the particle beam 12, which in FIG. 1 is symbolized by a dash-and-dot line 18, passes through a first point of deflection 20 and a second point of deflection 22, which in the direction of propagation of the beam is located behind the first point of deflection 20 and at a distance from the first point of deflection 20, and in that the first point of deflection 20 and the second point of deflection 22 line on an axis in line with a predetermined point of impact 24 of the particle beam 12 on the target 16, and in that the particle beam 12 can be deflected by the deflection device in the direction of propagation of the beam with respect to the first point of deflection 20, independently from a deflection of the particle beam 12 with respect to the second point of deflection 22.

With this embodiment, the deflection device includes a first deflector 26 including a deflection element 28, which in this embodiment is formed by a coil configuration in the form of a quadrupole. A first aperture 30 is provided for the first deflector 26 in this embodiment, which is located at a distance in the direction of propagation of the beam from the deflection element 28, and is provided behind the element. The first aperture 30 includes an aperture opening with circular cross-section, the first point of deflection 20 being located in the center of the aperture opening.

Further, the deflection device includes a second deflector 32 including a deflection element 34, which in this embodiment is formed by a coil configuration in the form of a quadrupole. A second aperture 36 in this embodiment includes a circular aperture opening, the second point of deflection 22 being located in the center of the aperture opening.

The device 2 further includes a controlling device 38, which serves to control the deflection elements 28, 34 with a deflection current and to control a high-voltage generator 40 and the particle source 10, as is explained in detail further below. The first deflector 26 and the second deflector 32 are independently controllable by the controlling device 38 for the independent deflection of a particle beam 12 with respect to the first point of deflection 20 and the second point of deflection 22.

With this embodiment, the deflectors 26, 32 are each provided for deflecting the particle beam 12 transversely to central axis 18 along axes perpendicular to each other; that is, for deflecting the particle beam 12, which propagates in the Z-direction, into the X-direction and Y-direction.

As in shown in FIG. 1, in this embodiment, the first aperture 30 in the direction of propagation of the beam is provided approximately in the region of the deflection element 34 of the second deflector 32. For first aperture 30, which in this embodiment consists of an electrically conductive material, a first measuring unit 42 is provided for measuring an electric current, which results from the impact of the particle beam 12 on the first aperture 30. The output of the first measuring unit 42 is connected with the controlling device 38.

Correspondingly, the second aperture 36, which is located opposite the target 16, also consists of an electrically conductive material, wherein a second measuring unit 44 is provided for the aperture. The second measuring unit 44 measures an electric current in a first mode of operation, which results from the impact of the particle beam 12 on the surface of the aperture 36, which faces away from the target 16. In a second mode of operation, the second measuring unit 44 measures an electric current, which results from the electrically charged particles backscattered from the target 16. The backscattering of electrically charged particles from the target 16 is indicated by arrows 46 in FIG. 1.

For the purpose of focusing the particle beam 12, the device 2 is provided with focusing device, which in this embodiment is provided by an electromagnetic lens 48 which in the embodiment is located in the direction of propagation of the beam behind the second deflector 32.

The XUV radiation, which is created by the electrically charged particles impacting the target 16, exits from a housing 4 through an outlet window 49 which is formed laterally in the housing 4, as indicated by the reference number 50. A filter 52 can be provided in the outlet window 4 for the spectral filtering of XUV radiation.

In order to prevent the electrons backscattered from the target 16 from impacting the outlet window 48 and subjecting the window to a static electrical charge, the outlet window 49 is surrounded by a capture ring 54, which is connected to a positive potential and captures the backscattered electrons flowing in the direction of the outlet window 40. The capture ring 54, therefore, is connected with the plus pole of a voltage source 56, whose minus pole is connected with the housing 4 and is grounded.

The functionality of the inventive device is as follows.

When operating the device 2, electrons emerge from the particle source 10, and are accelerated via the annular anode 14 in the direction of the target 16, wherein the central axis 18 of the particle beam 12 passes through the first point of deflection 20 and the second point of deflection 22. Since the points of deflection 20, 22 are in line with the specified point of impact of the particle beam 12 on the target 16, the electrons impact this point 24 on the target 16, so that the XUV radiation is generated, which exits the device through the outlet window 49.

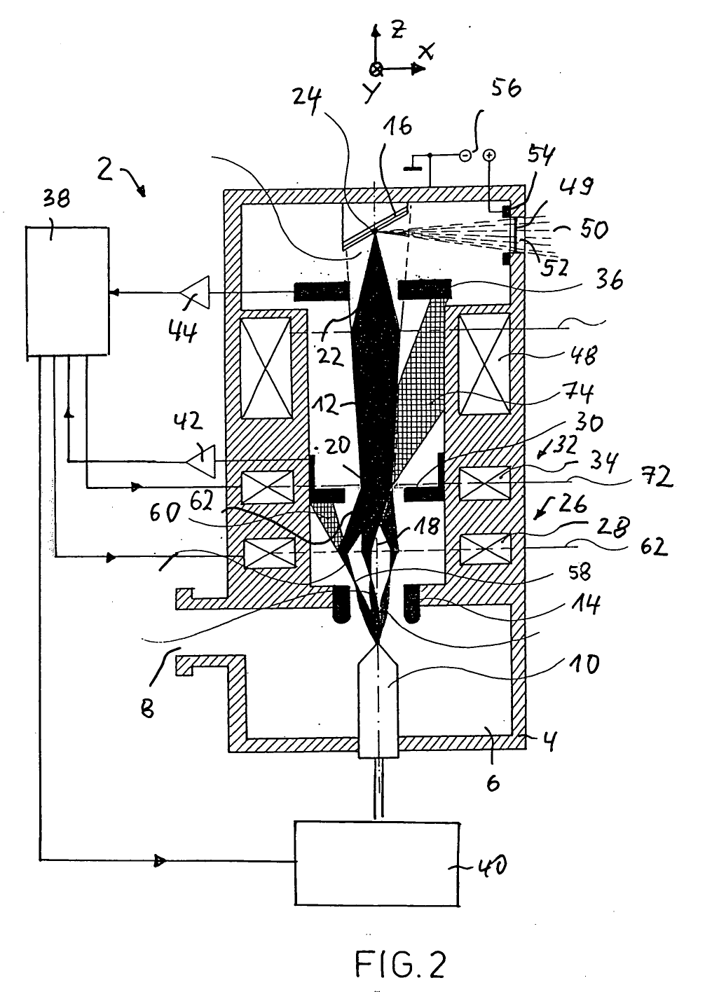

FIG. 2 represents a mode of operation of the device 2 in which, in terms of the direction of the particle beam 12, an error/disturbance occurred. Such an error, for example, may be that a heating filament tip of the particle source 10 slopes downward, an external magnetic field is activated, or a thermal expansion becomes active. In this case, the particle beam 12 passes through the anode opening of the annular anode 14 at an angle. In this connection, it is worth mentioning that, for example, when using a Wehnelt cylinder surrounding the heating filament tip, the electrons in the direction of propagation of the beam approximately in the plane of the annular anode 14 experience an initial bundling (initial cross-over), as is indicated in FIG. 2 with the reference symbol 58. Following the first cross-over, the electrons diverge due to the various action mechanisms, for example, based on Boersch's effect, which describes the repulsive forces of charged electrodes of the same name. Since the high voltage applied to annular anode 14 is no longer active after the electrons have left the plane of annular anode 14, the electrons continue to flow in the direction in that they flew after leaving the cross-over.

As shown in FIG. 2, the electrons 60, presented in hatched lines with reference symbol 60, therefore would impact on the first aperture 30, and, therefore, be unable to reach the target 16.

Because the electrons impact the first aperture 30, the first measuring unit 42 measures a current and transmits a corresponding signal to the controlling device 38.

Subsequently, the controlling device 38 controls the deflection element 28 of the first deflector 26 by way of a deflection current. The plane of action of the first deflector 26 is symbolized in FIG. 2 by a dotted line 62. The controlling device 38 controls the deflection current, so that the particle beam 12 is deflected in such a way that its central axis 18 passes through the first point of deflection 20. In FIG. 2, the resulting direction of the particle beam 12 is indicated with the reference symbol 62.

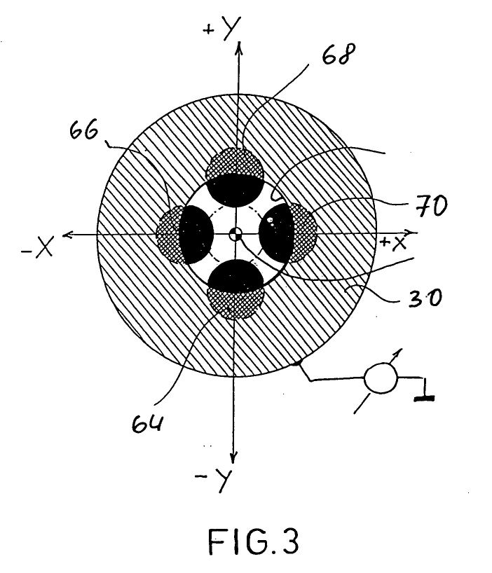

The determination of the deflection current for the deflector 26, which is necessary to deflect the particle beam 12 through the first point of deflection 20, is explained in greater detail in the following in FIG. 3.

In this embodiment, the deflector 26 is formed by a quadrupole consisting of four electromagnetic coils arranged in a square, and by way of which the electron beam may be deflected both in the X-direction and in the Y-direction. If the electron beam passes through the aperture hole of the first aperture 30 and through the first point of deflection 20, the current measured by the first measuring unit 42 is zero. The measuring unit 42 measures the current only when the particle beam 12 impacts the aperture. In this case, the controlling device 38 controls the deflection element 28 in such a way that the particle beam 12 subsequently is moved into the position designated in FIG. 3 with the reference symbols 64, 66, 68, 70. These positions 64, 66, 68, 70 are selected only as an example, so that about one-half of the cross-sectional surface of the particle beam 12 impacts the first aperture 30, so that the current measured by the first measuring unit 42 corresponds to about one-half of the maximum current, which is measured when the particle beam 12 completely impacts the first aperture 30.

With the small angles of deflection of the central axis 18 of the particle beam 12, which are produced in this case, proportionality exists between the deflection currents and the deflection path of the particle beam 12. Due to this proportionality, the deflection currents flowing in the X-direction and in the Y-direction, which are necessary to deflect the particle beam 12 in such a way that its central axis 18 passes through the center of the first aperture 30, and thus through the first point of deflection 20, can be determined as follows:
I_{Ym}=(I₁+I₃)2
I_{Xm}=(I₂+I₄)2
In which:
I₁: Deflection current in position 64 of the particle beam 12
I₂: Deflection current in position 66 of the particle beam 12
I₃: Deflection current in position 68 of the particle beam 12
I₄: Deflection current in position 70 of the particle beam 12
I_{Ym}: Deflection current for positioning of the particle beam 12 in the center of the aperture hole in the Y-direction
I_{Xm}: Deflection current for positioning of the particle beam 12 in the center of the aperture hole in the X-direction.

If the required deflection currents are determined by this method, the controlling device 38 controls the coils of the deflection element 28 with these deflection currents, so that the central axis 18 of the electron beam 12 then passes through the center of the aperture hole of the first aperture 30 and thus through the first point of deflection 20. During this process, the particle beam 12 remains divergent, since the first deflection unit or deflector 26 has no focusing effect, but exclusively produces a lateral deflection of the particle beam 12.

Following the deflection, the particle beam 12 would propagate according to the course 74, as shown hatched in FIG. 2, and, for example, impact on the second aperture 36 and a lateral wall of the vacuum chamber 6, so that it would not be able to reach the target 16.

In order to deflect the particle beam 12 in such a way that its central axis passes through the center of the second aperture 36 and thus through the second point of deflection 22, the second measuring unit 44 first measures the current created at the time of the particle beam 12 impacting the second aperture 36. Subsequently, the controlling device 38 determines in the above-described manner, with respect to a deflection by the first deflector 26, the currents required for deflecting the particle beam 12 in the X-direction and the Y-direction, and controls the deflection element 34 of the second deflector 32 with these currents. On this basis, the particle beam 12 is so deflected that the beam passes through the second point of deflection 22. The plane of action of the second deflector 32 is designated with reference number 72 in FIG. 2.

Since, according to these deflections, the central axis 18 of the particle beam 12 both passes through the first point of deflection 20 and the second point of deflection 22, and the points of deflection 20, 22 are located along the axis with the specified impact point 24 on the target 16, the particle beam 12 impacts in the desired manner at the predetermined point of impact 24 on the target 16. Prior to impacting on the target 16, the particle beam 12 is focused by the focusing device 48, which in this embodiment includes an electromagnetic lens.

While determining the deflection currents, a second measuring unit 44 is in the first mode of operation in that the unit measures an electric current, which results from the impact of the particle beam 12 on the surface of the second aperture 36, which faces away from the target 16. On conclusion of the above-described procedures, the particle beam 12 no longer impacts on the second aperture 36, so that no corresponding current is measured subsequently.

In a second mode of operation, the second measuring unit 44 then measures an electric current, which results from electrons backscattered from the target 16. Since this current is a measure for the target current of the target 16, the current can be used for regulating or controlling the target current. For this purpose, the controlling device 38 controls the particle source 10 in such a way that the source generates a particle beam 12, which leads to the respective desired target current. By this method, a precise regulation of the target current is possible, which, with a constant high voltage between the particle source 10 and the annular anode 14 provides a direct measure of the flow of photons.

The inventive device 7 enables a high precision deflection of the particle beam 12 by the use of simple expedients and, at the same time, a high precision regulation of the target current. Therefore, it is, for example, particularly suitable for application in imaging processes, and in inspection, and in measuring procedures in the XUV range.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

What is claimed is:

1. A device for generating X-ray or XUV radiation, comprising:
a) a device for directing a particle beam of electrically charged particles towards a target;
b) a deflection device for deflecting the particle beam in such a way that the central axis (z-axis) of the particle beam passes through a first point of deflection and a second point of deflection located at a distance from the first point of deflection in the direction of propagation of the beam;
c) the deflection device including a first deflector for deflecting the particle beam in such a way that the central axis of the particle beam passes through the first point of deflection, and a second deflector at a distance from the first deflector in the direction of propagation of the particle beam, in order to deflect the particle beam in such a way that the central axis of the particle beam passes through the second point of deflection;
d) the particle beam can be deflected by the first and second deflectors with respect to one point of deflection independent of a deflection with respect to another point of deflection; and
e) each of the first and second deflectors being configured for deflecting the particle beam along two axes perpendicular to each other (x-axis and y-axis), and in such a way that the first and second points of deflection lie on an axis in line with a predetermined or predeterminable point of impact of the particle beam on the target.

2. A device as defined in claim 1, wherein:
a) a controlling device for controlling the deflection device is provided.

3. A device as defined in claim 2, wherein:
a) the first deflector and the second deflector are controllable independently from one another by the controlling device in such a way that the particle beam with respect to one point of deflection can be deflected independently from a deflection with respect to the other point of deflection.

4. A device as defined in claim 1, wherein:
a) each of the first and second deflectors includes at least one deflection element.

5. A device as defined in claim 4, wherein:
a) the deflection element includes at least one of a coil and a coil configuration.

6. A device as defined in claim 4, wherein:
a) the deflection element includes at least one electrostatic deflection plate.

7. A device as defined in claim 1, wherein:
a) the deflection device is configured for deflecting the particle beam along two axes, which are perpendicular to one another.

8. A device as defined in claim 1, wherein:
a) at least one of the first and second deflectors is provided with an aperture, which is arranged in the direction of propagation of the beam behind the deflection element of the deflector.

9. A device as defined in claim 8, wherein:
a) the aperture includes a first aperture provided for the first deflector, and the first aperture is provided in the direction of propagation of the beam in a region of a plane of action of a deflection element of the second deflector.

10. A device as defined in claim 9, wherein:
a) the aperture includes a second aperture provided for the second deflector.

11. A device as defined in claim 8, wherein:
a) the aperture at least in part includes an electrically conductive material; and
b) a measuring unit for measuring an electric current is provided for the aperture, the electric current resulting from the particle beam which impacts on the aperture.

12. A device as defined in claim 11, wherein:
a) the measuring unit is connected with the controlling device for controlling the deflection device in such a way that the deflection of the particle beam results as a function of a current measured by the measuring unit.

13. A device as defined in claim 8, wherein:
a) a measuring unit is provided for the aperture located opposite the target, which in a first mode of operation measures an electric current resulting from the impact of the particle beam on the target, and which in a second mode of operation measures an electric current resulting from the electrically charged particles, which are backscattered from the target.

14. A device as defined in claim 13, wherein:
a) the measuring unit is connected with one of the controlling device and a regulating device, which, as a function of a current measured by the measuring unit in a second mode of operation, respectively controls and regulates the target current by controlling a particle source for generating the particle beam.

15. A device as defined in claim 1, wherein:
a) a focusing device is provided for focusing the particle beam on the target.

16. A device as defined in claim 15, wherein:
a) the focusing device is located behind the deflection device in the direction of propagation of the beam.

17. A device as defined in claim 4, wherein:
a) the deflection element includes a quadrupole.
